(19) United States
(12) Patent Application Publication
(10) Pub. No.: US 2015/0294650 A1
(43) Pub. Date: Oct. 15, 2015

(54) KEY FOR KEYBOARD MUSICAL INSTRUMENT, AND METHOD FOR MANUFACTURING THE KEY

(71) Applicant: Yamaha Corporation, Hamamatsu-shi (JP)

(72) Inventor: Kenichi NISHIDA, Hamamatsu-shi (JP)

(21) Appl. No.: 14/685,445

(22) Filed: Apr. 13, 2015

(30) Foreign Application Priority Data
Apr. 14, 2014 (JP) 2014-082858

(51) Int. Cl. G10C 3/12

(52) U.S. Cl. CPC G10C 3/12

(57) ABSTRACT

A key includes upper, front and side walls each having a flat shape, and a downwardly-opening space. The key includes a first part (e.g., the upper and front walls) normally visible from outside with the key assembled to the keyboard musical instrument; and a second part (e.g., the side walls) normally invisible from outside with the key assembled to the keyboard musical instrument. In molding, a first molding process is performed where resin is poured into a first mold to mold one of the part normally visible from outside and the part normally invisible from outside, and then a second molding process is performed where the one part molded by the first molding process is inserted into a second mold and resin is poured into the second mold so that the other of the parts is molded and thus the upper wall, front wall and side walls are insert-molded.

### BACKGROUND

The present invention relates to a keyboard musical instrument's key in the form of a molded key, and a method for manufacturing the key.

Keys for keyboard musical instruments have heretofore been well known which include: an upper wall of a flat shape; a front wall of a flat shape extending downward from the front end of the upper wall; side walls extending from left and right side ends of the upper wall; and a downwardly-opening interior space defined with the upper, flat and side walls. The keys of this type are manufactured by integrally molding resin using a mold, as shown, for example, in Japanese Patent Application Laid-open Publication Nos. 2008-191650, 2009-103909 and 2010-286694 and U.S. Patent Application Publication No. 2009/100987 which corresponds to the Japanese Patent Application Laid-open Publication No. 2009-103909.

The conventionally-known keys for keyboard musical instruments, each of which includes the upper, front and side walls, have a relatively large overall size. Thus, in cases where the keys are integrally formed or molded using a mold, flows of resin would become complicated and long in length, and weld lines, flow marks, etc., degrading the outer appearance of the keys, can easily occur. Particularly, in the case of a key, such as a white key, elongated in a front-rear direction, if resin is poured from the back of the key, the resin flows through mold portions corresponding to the upper and side walls of the key into a mold portion corresponding to the front wall of the key, and weld lines can easily occur in the front wall. Further, if a rib that is an actuator section for actuating a switch is provided inside the key, sink marks tend to occur in the upper surface of the upper wall and deteriorate the outer appearance of the key.

As an approach to solve the aforementioned problems, it is conceivable to form only portions of the key visible from outside the key (i.e., visible part of the key) and then affix to the visible part other portions of the key invisible from outside the key (i.e., invisible part of the key). However, this approach would take enormous time and labor to affix the invisible part to the visible part, and processing has to be performed for securing a high accuracy of components in the invisible part of the key and enhancing the outer appearance of the key in view of an outer appearance of a connection portion between the visible part and the invisible part. Further, for the reason that sink marks easily occur, a high-grade key having a deep and heavy feel cannot be formed by resin molding alone.

### SUMMARY OF THE INVENTION

In view of the foregoing prior art problems, it is an object of the present invention to provide an improved a key for a keyboard musical instrument which can be manufactured into an enhanced outer appearance with a simple method.

In order to accomplish the above-mentioned object, the present invention provides an improved key for a keyboard musical instrument, which comprises a combination of: a first part including portions normally visible from outside with the key assembled to the keyboard musical instrument; and a second part including portions normally invisible from outside with the key assembled to the keyboard musical instrument. One of the first part and the second part is constructed as a first component by resin being poured into a first mold, and the other of the first part and the second part is constructed as a second component, molded integrally with the first component, by resin being poured into a second mold with the first component inserted in the second mold.

According to the present invention, the first part including portions (e.g., the upper wall and the front wall in the case of the white key, or the upper wall and upper portions of the front wall and the side walls in the case of the black key) normally visible from outside the key and the second part including portions (e.g., the side walls in the case of the white key, or lower portions of the front wall and the side walls in the case of the black key) normally invisible from outside the key are molded or formed, respectively as the first and second components, separately from each other by user of the first and second molds. Thus, during molding of the first part, which has only portions normally visible from outside, flows of the resin can be simplified and reduced in length, and weld lines, flow marks, etc. can be prevented from being produced in the upper wall, the front wall, etc. to be molded. Particularly, even where the resin is poured from the back of the key, no weld lines are produced in the front wall because, in the case of the white key, the resin flows through a mold portion corresponding to the upper wall to a mold portion corresponding to the front wall. In the case of the black key, on the other hand, no weld lines are produced in the front wall because the upper wall and the upper portions of the front wall and the side walls are short in length and the upper portion of the front wall has a small width in a horizontal left-right direction. Further, even in a case where a rib for actuating a switch is provided within the key, no sink marks would be produced in the upper surface of the upper wall if the rib is formed, as a portion belonging to the second part, separately from (i.e., independently of) the first part, because, in this case, the upper wall and the rib are not formed or molded simultaneously with each other. Further, because the second component is formed by insert-molding with the first component inserted therein, the first part normally visible from outside and the second part normally invisible from outside are formed integrally with each other, and thus, there is no need to perform a particular process for interconnecting the first part and the second part. As a result, the key for the keyboard musical instrument can be manufactured into a good outer appearance with a simple method.

In one embodiment, the key of the present invention may comprise: an upper wall of a flat shape extending horizontally to define the upper surface of the key; a front wall of a flat shape extending downward from the front end of the upper wall; side walls, each having a flat shape, extending downward respectively from left and right ends portions of the upper wall; and a downwardly-opening interior space defined by the upper wall, the front wall and the side walls, and individual one of the upper wall, the front wall and the side walls may belong to at least one of the first part and the second part.

In the case where the key of the invention is a white key, the upper wall and the front wall may belong to the first part, and the side walls of the key may belong to the second part. In the case where the key is a black key, on the other hand, the upper wall, an upper portion of the front wall and upper portions of the side walls of the key may belong to the first part, and lower portions of the front wall and the side walls of the key may belong to the second part.

In one embodiment, the key of the present invention may comprise: an upper wall of a flat shape extending horizontally to define the upper surface of the key; a front wall of a flat shape extending downward from the front end of the upper wall; side walls, each having a flat shape, extending downward respectively from left and right ends portions of the upper wall; and an inner layer surrounded by the front wall and the side walls and forming a lower layer of the upper wall. Here, at least the upper wall may belong to the first part, and at least the inner layer may belong to the second part. Because the interior layer can be formed of resin softer and lighter than the resin forming the upper wall. Thus, even if the thickness of the key increases due to the addition of the interior layer, the key is capable of imparting a good key-depressing touch feel without unnecessarily increasing the overall weight of the key.

In one embodiment, an outer surface of the second part in a connection portion between the first part and the second part may be located inward of an outer surface of the first part in the connection portion. Thus, even when some error has occurred during molding of the part invisible from outside the key (i.e., invisible part) or the part visible from outside the key (i.e., visible part), the molded key can secure a good outer appearance, without requiring a finishing process of the invisible part because the outer surface of the invisible part is located inward of the outer surface of the visible part.

In one embodiment, the resin for forming the second part may be of a lower hardness than the resin for forming the first part. In molding of the part invisible from outside the key, for example, a resin material may be used which has a relatively high resilience, such as an ABS material containing much rubber component or a rubber material. In such a case, the hardness of the invisible part (the side walls in the case of the white key, or the lower portions of the front wall and the side walls in the case of the black key) is lower than the hardness of the visible part (the upper wall and the front wall in the case of the white key, or the upper wall and the upper portions of the front wall and the side walls in the case of the black key), so that the invisible part can perform a vibration suppression function. Although, once a nail of a human player hits the resin-formed key during a performance on the keyboard musical instrument, there may occur a “whang” sound uncomfortable as compared to a wooden key, such an uncomfortable sound can be suppressed by the vibration suppression function of the invisible part.

In one embodiment, the resin for forming the first part may be of a different color from the resin for forming the second part. For example, the color of the resin to be poured into the mold (first or second mold) at the time of molding of the visible part is white in the case of the white key or black in the case of the black key. However, in a case where a selected color of the resin to be poured into the mold (first or second mold) at the time of molding of the invisible part is similar to a color of wood, the invisible part (the side walls in the case of the white key, or the lower portions of the front wall and the side walls in the case of the black key) has a color of wood, so that the invisible part can have a similar outer appearance to a wooden key. Further, even where the selected color of the resin to be poured into the mold (first or second mold) at the time of the molding of the invisible part is not similar to a color of wood, the present invention can provide a key rich in aesthetic variation with the invisible part differentiated in color from the visible part (the upper wall and the front wall in the case of the white key, or the upper wall and the upper portions of the front wall and the side walls in the case of the black key).

Further, in one embodiment, the key of the present invention may comprise a hinge section provided at the rear end of the key and adapted to be fixed to a frame of the keyboard musical instrument, the hinge section being constructed to deform in response to motion of the key and thereby allow the key to perform stroke movement. Here, the hinge section may belong to the second part and be formed integrally with the remaining portion of the second part. Because the hinge section is molded, separately from the first part visible from outside the key, as a section belonging to the second part, flows of the resin can be simplified and reduced in length during molding of the first or visible part, and thus, the key for the keyboard musical instrument can be formed into a good outer appearance with a simple method, similarly to the aforementioned.

Because the hinge section can be formed or molded of a different material from the first part, such as the upper wall, of which a high hardness is required, resilient and soft resin can be suitably used to form the hinge section. Namely, if the hardness of the resin to be poured into the mold at the time of the molding of the invisible part (the second part) is lower than the hardness of the resin to be poured into the mold at the time of the molding of the invisible part (the first part), then the hinge section can resiliently deform with ease. In the molding of the visible part (the upper wall and the front wall in the case of the white key, or the upper wall and the upper portions of the front wall and the side walls in the case of the black key), resin of a high hardness is used with a view to preventing scratches etc. Thus, if the same resin as poured into the mold in the molding of the visible part (the first part) is used in the molding of the hinge section as well, then bending rigidity of a support section increases, so that a touch feel of the key during key depression would deteriorate. However, if the resin to be poured into the mold in the molding of the invisible part (the second part) (i.e., molding of the support section) is lowered in hardness, the hinge section becomes easily deformable, so that the touch feel of the key during key depression can be improved.

In one embodiment, the hinge section may include a plurality of hinge members fixed to the frame at different heights with respect to a stroke direction of the key. Thus, a pivot point of the key at the time of depression of the key (i.e., a virtual pivot point that is determined by combination of respective pivot points of the plurality of hinge members) is located substantively more rearward than the pivot point of the key including only one hinge member. Thus, even in a case where the keys is of a low cost type where an actual distance from the key's front end to the pivot point of the hinge section is relatively small, it is possible for a user (human player) to obtain a preferable key depression stroke feel muck like that obtainable by parallel displacement of the key, as with a high-grade type key where the distance from the key's front end to a support point of the hinge section is relatively large.

It should be appreciated that the present invention can be practiced as an invention of a method for manufacturing the key for a keyboard musical instrument without being limited only to the key for a keyboard musical instrument.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

Certain preferred embodiments of the present invention will hereinafter be described in detail, by way of example only, with reference to the accompanying drawings, in which:

FIG. 1 is a plan view of pluralities of white and black keys in a keyboard musical instrument which are constructed in accordance with an embodiment of the present invention and which belong to first to third groups;

FIG. 2 is a plan view of the plurality of white keys belonging to the first group;

FIG. 3A is a longitudinal sectional view of the white key taken along the 3A-3A line of FIG. 2, and FIG. 3B is an enlarged cross-sectional view of the white key taken along the 3B-3B line of FIG. 2;

FIG. 4A is a longitudinal sectional view showing portions of the white key and upper and lower molds, extending along a front-rear direction of the white key, in a first molding process for forming an outer appearance part of the white key, and FIG. 4B is a fragmentary enlarged cross-sectional view of the white key and the upper and lower molds taken along the 4B-4B line of FIG. 4A;

FIG. 5A is a longitudinal sectional view showing the white key and upper and lower molds, extending along the front-rear direction of the white key, in a second molding process for integrally forming a non-outer-appearance part of the white key, and FIG. 5B is an enlarged cross-sectional view of the white key and the upper and lower molds taken along the 5B-5B line of FIG. 5A;

FIG. 6 s a plan view of the plurality of black keys belonging to the third group of FIG. 1;

FIG. 7A is a longitudinal sectional view of the black key taken along the 7A-7A line of FIG. 6, FIG. 7B is an enlarged view of a section encircled at X in FIG. 7A, and

FIG. 7C is an enlarged cross-sectional view of the black key taken along the 7C-7C line of FIGS. 6 and 7A;

FIG. 8A is a longitudinal sectional view showing portions of the black key and upper and lower molds, extending along the front-rear direction of the black key, in a first molding process for forming an outer appearance part of the black key, and FIG. 8B is a fragmentary enlarged cross-sectional view of the black key and the upper and lower molds taken along the 8B-8B line of FIG. 8A;

FIG. 9A is a longitudinal sectional view showing the black key and upper and lower molds, extending along the front-rear direction of the black key, in a second molding process for forming a non-outer-appearance part of the white key, and FIG. 9B is an enlarged cross-sectional view of the black key and the upper and lower molds taken along the 9B-9B line of FIG. 9A;

FIGS. 10A and 10B show a modified method for forming the white key, of which FIG. 10A is a longitudinal sectional view showing portions of the white key and upper and lower molds, extending along the front-rear direction of the white key, in a first molding process for integrally forming a non-outer-appearance part of the white key and FIG. 10B is a fragmentary enlarged cross-sectional view of the white key and the upper and lower molds taken along the 10B-10B line of FIG. 1 OA;

FIGS. 11A and 11B show the modified method for forming the white key, of which FIG. 11A is a longitudinal sectional view showing portions of the white key and upper and lower molds, extending along the front-rear direction of the white key, in a second molding process for integrally forming an outer appearance part of the white key and FIG. 11B is a fragmentary enlarged cross-sectional view of the white key and the upper and lower molds taken along the 11B-11B line of FIG. 11A;

FIGS. 12A and 12B show another method for forming the black key, of which FIG. 12A is a longitudinal sectional view showing portions of the black key and upper and lower molds, extending along the front-rear direction of the black key, in a first molding process for integrally forming a non-outer-appearance part of the black key and FIG. 12B is a fragmentary enlarged cross-sectional view of the black key and the upper and lower molds taken along the 12B-12B line of FIG. 12A;

FIGS. 13A and 13B show the modified method for forming the black key, of which FIG. 13A is a longitudinal sectional view showing portions of the black key and upper and lower molds, extending along the front-rear direction of the black key, in a second molding process for integrally forming an outer appearance part of the black key and FIG. 13B is a fragmentary enlarged cross-sectional view of the black key and the upper and lower molds taken along the 13B-13B line of FIG. 13A;

FIG. 14A is a longitudinal sectional view of a modified white key corresponding to FIG. 3A, FIG. 14B is an enlarged longitudinal sectional view of a section encircled at A of FIG. 14A, and FIG. 14C is an enlarged plan view of the section encircled at A of FIG. 14A; and

FIGS. 15A and 15B show still another modified method for forming the white key, of which FIG. 15A is a longitudinal sectional view showing portions of the white key and upper and lower molds, extending along the front-rear direction of the white key, in a second molding process for integrally forming a non-outer-appearance part of the white key and FIG. 15B is a fragmentary enlarged cross-sectional view of the white key and the upper and lower molds taken along the 15B-15B line of FIG. 15A.

### DETAILED DESCRIPTION

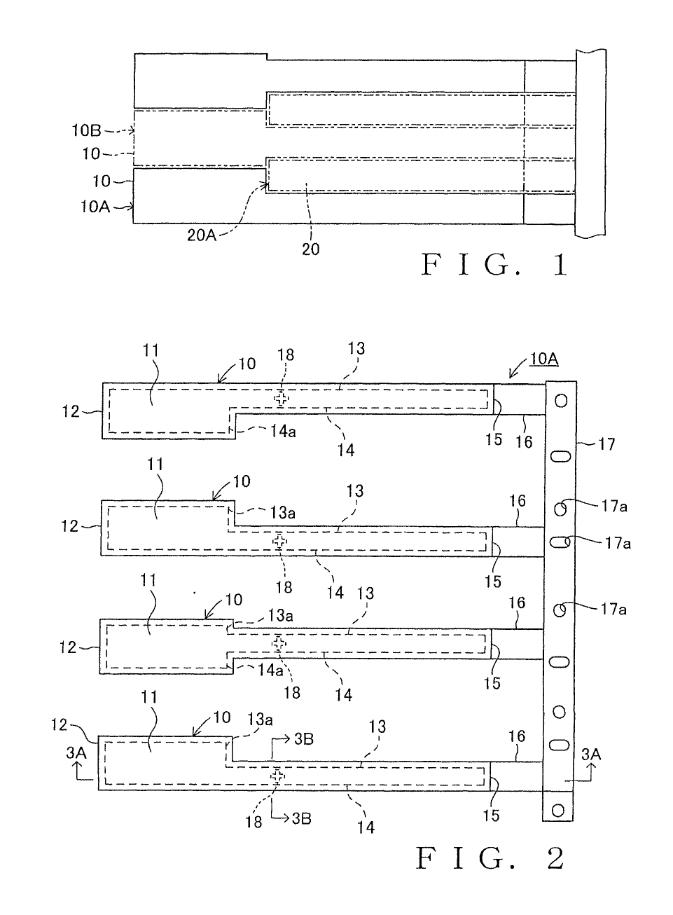

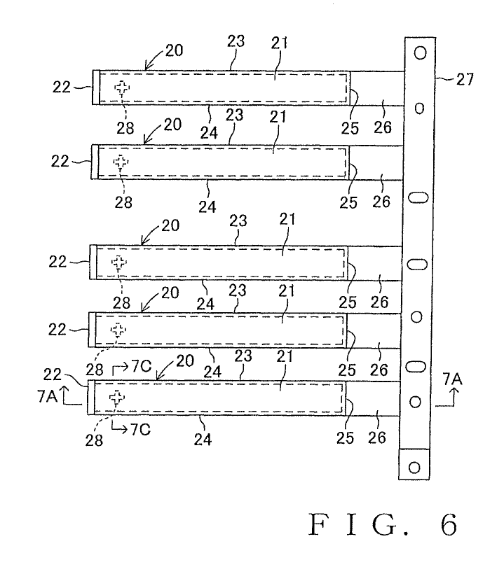

FIG. 1 is a plan view of a plurality of white keys 10 and a plurality of black keys 20 belonging to first to third groups 10A, 10B and 20A in a keyboard musical instrument. FIG. 2 is a plan view of the plurality of the white keys 10 belonging to the first group 10A. FIG. 6 is a plan view of the plurality of black keys 20 belonging to the third group 20A. Note that a left-right direction in FIGS. 1, 2 and 6 corresponds to a front-rear direction of the white and black keys 10 and 20 while an up-down direction in the figures corresponds to a horizontal left-right direction of the white and black keys 10 and 20.

In the instant embodiment, the white and black keys 10 and 20 within one octave which do not adjoin one another are respectively divided into the first to third groups 10A, 10B and 20A and integrally molded separately for each of the first to third groups 10A, 10B and 20A. The white keys 10 belonging to the first group 10A correspond to four pitch names C, E, G and B, the white keys 10 belonging to the second group 10B correspond to three pitch names D, F and A, and the black keys 20 belonging to the third group 20A correspond to five pitch names C#, D#, F#, G# and A#.

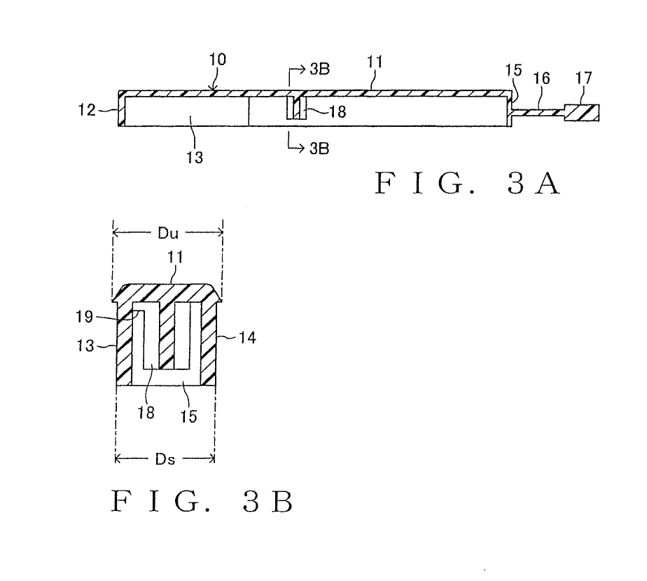

First, one of the white keys 10 belonging to the first group 10A shown in FIG. 2 will be described with reference to FIGS. 2, 3A and 3B. FIG. 3A is a longitudinal sectional view of the white key 10 taken along the 3A-3A line of FIG. 2, and FIG. 3B is an enlarged cross-sectional view of the white key 10 taken along the 3B-3B line of FIG. 2.

The white key 10 is formed integrally of resin and includes an upper wall 11, a front wall 12, side walls 13 and 14 and a rear wall 15. The upper wall 11 has a flat shape elongated in the front-rear direction, and the upper and lower surfaces of the upper wall 11 each extend in a horizontal plane. Note, however, that a width, in the horizontal left-right direction, of a front portion of the upper wall 11 is greater than a width, in the horizontal left-right direction, of a rear portion of the upper wall 11, and that a stepped portion is provided on an intermediate portion of the upper wall 11. The front wall 12 has a rectangular flat shape and extends vertically downward from the front end of the upper wall 11. The side walls 13 and 14, each of which too has a flat shape elongated in the front-rear direction, extend vertically downward from the left and right side ends of the upper wall 11. Although most portions of the side walls 13 and 14 extend in the front-rear direction, step portions 13a and 14a, which extend in the horizontal left-right direction at right angles to the front-rear direction, are provided in respective intermediate portions of the side walls 13 and 14 corresponding to the stepped portion of the upper wall 11. In this specification, these step portions 13a and 14a are assumed to be included in the side walls 13 and 14. The rear wall 15 too has a rectangular flat shape and extends vertically downward from the rear end of the upper wall 11. The front wall 12 connects at its left and right ends to the respective front ends of the side walls 13 and 14, and the rear wall 15 connects at its left and right ends to the respective rear ends of the side walls 13 and 14. These upper wall 11, front wall 12, side walls 13 and 14 and rear wall 15 together define an interior space of a stepped rectangular shape opening downwardly.

Further, in the white key 10, the outer surface, in a horizontal plane, of each of the side walls 13 and 14 is located slightly inwardly of the outer surface, in a horizontal plane, of each of the upper and front wall 11 and 12. Namely, a horizontal width, in the left-right direction, between the outer surfaces of the side walls 13 and 14 (namely, a distance, in the horizontal left-right direction, between the outer surface of the side wall 13 (left-side outer surface) and the outer surface of the side wall 14 (right-side outer surface)) is slightly smaller than a horizontal width of each of the upper wall 11 and the front wall 12 (i.e., a distance between the left and right side ends of the upper surface 11). More specifically, if the horizontal width, at a given position in the front-rear direction, of each of the side walls 13 and 14 is represented by Ds and the horizontal width of the upper wall 11 is represented by Du as shown in FIG. 3B, the horizontal widths Ds and Du are in a relationship of Ds<Du. Further, the outer surface (rear-side outer surface) of the stepped portion 13a or 14a of each of the side walls 13 and 14 is located slightly forward of a position, in the front-rear direction, of the stepped portion of the upper wall 11. The rear surface of the rear wall 15 coincides with the rear end of the upper wall 11. Further, a front end portion of the upper wall 11 is equal in width in the left-right direction to the front wall 12.

The rear wall 15 has, on its rear surface, a hinge section 16 and a fixing section 17 integrally connected with each other. The hinge section 16 has a small thickness in the up-down direction and extends rearward from the rear surface of the rear wall 15. The fixing section 17 has a rectangular cross-sectional shape elongated in the front-rear direction, and the hinge section 16 is connected at its rear end to the front surface of the fixing section 17. The fixing section 17 is fixed to a not-shown key frame of the keyboard musical instrument and has through-holes 17a formed, in appropriate positions thereof in the horizontal left-right direction, for passage therethrough fastening screws. With the fixing section 17 fixed to the not-shown key frame, the hinge section 16 resiliently deforms in an up-down stroke direction of the key in response to depression and release of the white key 10 to thereby permit vertical (up-down) pivoting movement of the front end of the white key 10.

Further, an actuator section 18 is provided on the lower surface of the upper wall 11 on a middle position, in the front-rear direction, of the white key 10. The actuator section 18 has a crisscross cross-sectional shape and is connected at its upper end to the lower surface of the upper wall 11. With the fixing section 17 fixed to the key frame, the actuator section 18 functions to turn on and off a not-shown key switch provided on the key frame. Further, on a portion of the lower surface of the upper wall 11 is provided a connection section 19 that interconnects the inner surface of an upper end portion of the side wall 13 and one outer end of an upper end portion of the actuator section 18 (FIG. 3B). This connection section 19 is a section which, when resin has been poured into upper and lower molds 32A and 32B, allows the resin to flow through a mold portion corresponding to the side wall 13 to a mold portion corresponding to the actuator section 18 in a later-described second molding step or process.

Of each of the white keys 10 assembled to the keyboard musical instrument, portions normally visible from outside the key 10 (such portions will hereinafter be referred to collectively as “first part” for convenience) are the upper wall 11 and the front wall 12, while portions normally invisible from outside the key 10 (such portions will hereinafter be referred to collectively as “second part” for convenience) are the other portions (e.g., the side walls 13 and 14, the rear wall 15, the hinge section 16, the fixing section 17, the actuator section 18 and the connection section 19). Note that “normally” in this context means a state where the key 10 is not being depressed. Although portions of the side walls 13 and 14 are visible from outside when another key adjoining that key is depressed, it is assumed here that such portions do not fall under the definition of “normally visible from outside”. According to the present invention, as will be later described in detail, the first part normally visible from outside and the second part normally invisible from outside are formed by two (two-stage) molding processes (first and second molding processes) using two molds (i.e., first and second molds), and insert-molding is performed in a latter one of the two molding process (i.e., second molding process). Either one of the first and second parts may be formed first. For convenience of description, a key section independently molded by the earlier process using the first mold (i.e., first molding process) will hereinafter be referred to as “first component”, while another key section insert-molded by the later process using the second mold (i.e., second molding process) will hereinafter be referred to as “second component”.

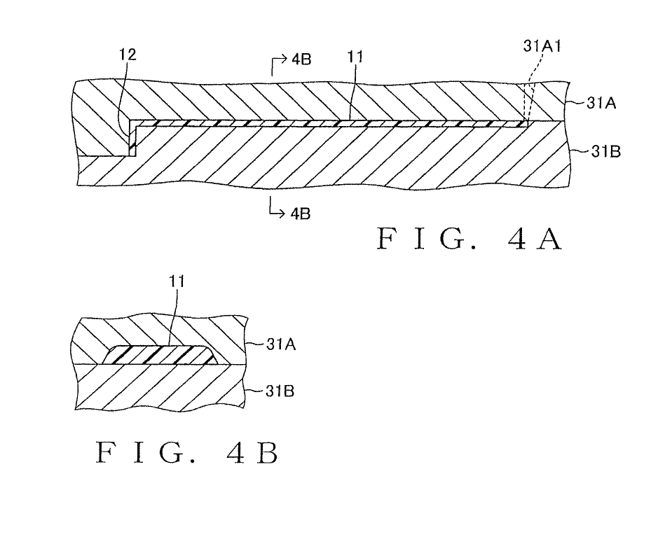

Next, a description will be given about a manner in which the plurality of the white keys 10, each constructed in the aforementioned manner, are formed or molded using the molds. First, the first molding process will be described with primary reference to FIGS. 4A and 4B. FIG. 4A is a longitudinal sectional view showing portions of the white key 10 and upper and lower molds 31A and 31B, extending along the front-rear direction of the white key 10, in the first molding process for forming the upper wall 11 and front wall 12 (i.e., the first part) of the white key 10. FIG. 4B is a fragmentary enlarged cross-sectional view of the white key and the upper and lower molds 31A and 31B taken along the 4B-4B line of FIG. 4A. Note that, in the white key 10, the upper and lower walls 11 and 12 constitute the first part (in other words, a top part) normally visible from outside with the white key 10 assembled to the keyboard musical instrument; in the following description, the upper and lower walls 11 and 12 constituting the first part will be described also as “outer appearance part”. Further, the other portions of the white key 10 than the upper and front walls 11 and 12, such as the side walls 13 and 14, rear wall 15, hinge section 16, fixing section 17, actuator section 18 and connection section 19, constitute the second part normally invisible from outside and will be referred to also as “non-outer-appearance part”.

The upper and lower molds 31A and 31B are provided which, as shown in FIGS. 4A and 4B, define therebetween a space for integrally forming the upper wall 11 and the front wall 12 constituting the appearance part (i.e., the first part) of the white key 10. Then, resin is poured into the space through a filler port 31A1 formed through the upper mold 31A so that the upper wall 11 and the front wall 12 are formed in the upper and lower molds 31A and 31B, after which the upper and lower molds 31A and 32B are pulled upward and downward, respectively, away from each other and then the upper wall 11 and the front wall 12 molded are taken out. In this case, the filler port 31A1 may be provided at any desired position other than the illustrated position as long as an undesired mark of the filler port 31A1 is invisible from outside with the molded white key 10 assembled to the keyboard musical instrument. Further, the resin to be poured is of a relatively high hardness and is of a white color corresponding to the white key 10. In this manner, the first part, comprising the upper wall 11 and the front wall 12, of the white key 10 is molded by the resin being poured into a first mold (31A and 31B), and the thus-molded part becomes the first component of the white key 10.

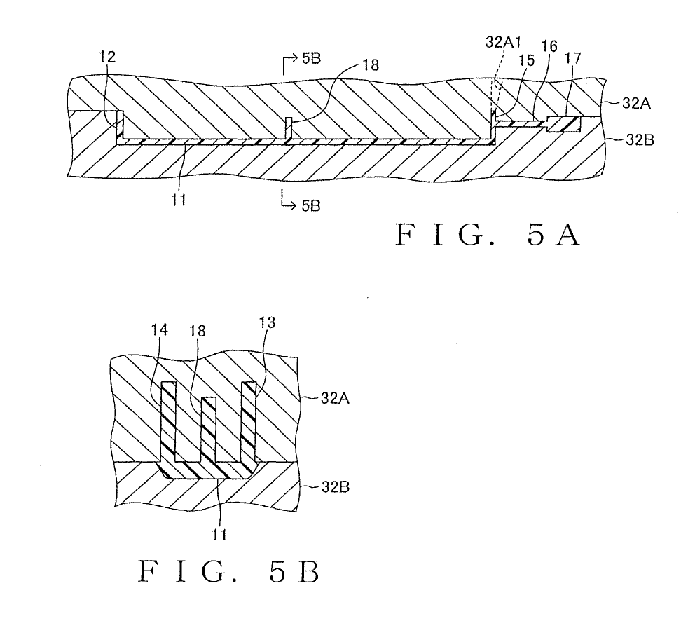

Next, the second molding process will be described. FIG. 5A is a longitudinal sectional view showing portions of the white key 10 and the upper and lower molds 32A and 32B, extending along the front-rear direction of the white key 10, in the second molding process for integrally forming the side walls 13 and 14, rear wall 15, hinge section 16, fixing section 17, actuator section 18 and connection section 19 that constitute the non-outer-appearance part (i.e., the second part) of the white key 10. FIG. 5B is an enlarged cross-sectional view of the white key 10 and the upper and lower molds 32A and 32B taken along the 5B-5B line of FIG. 5A. Note that the line along which the longitudinal section of FIG. 5A is taken corresponds to the line 3A-3A along which the longitudinal section of FIG. 2 is taken.

In the second molding process, the upper and lower molds 32A and 32B are provided which, as shown in FIGS. 5A and 4B, define therebetween a space for integrally forming the white key 10 including the upper wall 11 and the front wall 12. In this case, first the molding comprising the upper wall 11 and the front wall 12, formed in the first molding process as above, is inserted or assembled into an upper surface recess of the lower mold 32B, and then, the upper mold 32A is positioned over and fixed to an upper portion of the lower mold 32B. Then, resin is poured into the space through a filler port 32A1 formed through the upper mold 32A so that the side walls 13 and 14, rear wall 15, hinge section 16, fixing section 17, actuator section 18 and connection section 19 other than the upper and front walls 11 and 12 are integrally formed, after which the upper and lower molds 32A and 32B are pulled upward and downward, respectively, away from each other and then the white key 10 having been molded as above is taken out. By this insert-molding, the side walls 13 and 14, rear wall 15, hinge section 16, fixing section 17, actuator section 18 and connection section 19 other than the upper wall 11 and the front wall 12 are formed integrally with the upper and front walls 11 and 12 formed in the first molding process. Note that, in this case, the actuator section 18 is formed by the poured resin flowing into a mold portion corresponding to the actuator section 18 through a space (not visible in the figures) corresponding to the side wall 13 and the connection section 19.

In this case too, the filler port 32A1 may be provided at any desired position other than the illustrated position as long as an undesired mark of the filler port 32A1 is invisible from outside with the molded white key 10 assembled to the keyboard musical instrument. Further, the resin to be poured may be of hardness lower than the hardness of the resin used in the first molding process, and the resin may comprise a resin material having a relatively high resilience, such as an ABS material containing much rubber component or a rubber material. Further, in this case, the resin has color, such as brown, yellow or yellow-brown, similar to color of a wooden key. In the aforementioned manner, the second part of the white key 10, comprising the side walls 13 and 14, rear wall 15, hinge section 16, fixing section 17, actuator section 18 and connection section 19, other than the first part is molded by the resin being poured into the second mold (32A and 32B) with the first part (first component) inserted in the second mold, and this second part becomes the second component of the white key 10.

According to the instant embodiment, as described above, the white key 10 is integrally formed by the first molding process and the second molding process that is the insert-molding, and thus, the following advantageous benefits are achievable. Namely, because the first molding process does not form the side walls 13 and 14, rear wall 15, hinge section 16, fixing section 17, actuator section 18 and connection section 19, flows of the resin can be simplified, so that weld lines, flow marks, etc. can be prevented from being produced in the upper wall 11 and front wall 12 formed as the outer appearance part. Particularly, when the resin is poured from the back of the white key 10, the resin is allowed to flow into the mold portion corresponding to the front wall 12 only through the mold portion corresponding to the upper wall 11 even where the white key 10 has a long length in the front-rear direction and has a relatively large horizontal width (in the horizontal left-right direction), so that no weld line is produced in the front wall 12. Further, even where a rib constituting the actuator section 18 is provided within the white key 10, sink marks would not be produced in the upper wall 11 due to the provision of the rib in the first molding process performed on the upper wall 11 and the front wall 12. Further, by insert-molding the side walls 13 and 14, rear wall 15, hinge section 16, fixing section 17, actuator section 18 and connection section 19, constituting the non-outer-appearance part of the white key 10, in the second molding process, integrally with the upper wall 11 and the front wall 12, there is no need to perform a process for connecting the side walls 13 and 14, rear wall 15, hinge section 16, fixing section 17, actuator section 18 and connection section 19 to the upper wall 11 and the front wall 12. In this way, the white key 10 for the keyboard musical instrument can be formed into a good outer appearance with a simple method.

Further, in the instant embodiment of the white key 10, an outer surface, in a horizontal plane, of the side walls 13 and 14 that are included in the non-outer-appearance part (second part) is located inward of an outer surface, in a horizontal plane, of the upper wall 11 and the front wall 12 that are included in the outer-appearance part (first part). Stated differently, the outer surface of the non-outer-appearance part (second part) at least in a connecting portion between the outer-appearance part (first part) of the white key 10 and the non-outer-appearance part (second part) is located inward of the outer surface of the outer-appearance part (first part) of the white key 10. Thus, even when some error has occurred in the insert-molding of the side walls 13 and 14 in the second molding process, the molded white key 10 can secure a good outer appearance, without requiring a finishing process for, for example, shaving the side walls 13 and 14, because the side walls 13 and 14 are located inward of the upper wall 11 and the front wall 12.

The resin to be used in the first molding process has a relatively high hardness. Thus, the upper wall 11 and front wall 12 (i.e., the first part) of the white key 10 can have an increased rigidity so that scratches etc. can be prevented from being produced in the upper wall 11 and front wall 12 (i.e., the first part) after assemblage of the keyboard musical instrument; thus, the good outer appearance of the white key 10 can be maintained. Further, the side walls 13 and 14 and the hinge section 16 (the second part) are formed in the second molding process with the resin lower in hardness than the resin used in the first molding process. Thus, the side walls 13 and 14 (the second part) has a lower hardness than the upper and front walls 11 and 12, so that the side walls 13 and 14 (the second part) can perform a vibration suppression function. Generally, once a nail of a human player hits the resin-formed key, there may occur a “whang” sound uncomfortable as compared to a sound that would be generated by the nail of the human player hitting a wooden key. But, such an uncomfortable sound can be effectively suppressed by the vibration suppression function of the side walls 13 and 14. In addition, the hinge section 16 can become easier to deform resiliently, so that the white key 10 can impart a better touch feel at the time of depression of the key 10.

Further, in the above-described embodiment of the white key 10, the resin to be used in the second molding process has a color similar to a color of a wooden key, such as brown, yellow or yellow-brown, that is different from the white color of the resin to be used in the first molding process. In this manner, the side walls 13 and 14 (the second part) have a wood color and thus have generally the same outer appearance as a wooden key.

Although the white key 10 belonging to the second group 10B is somewhat different from the white key 10 belonging to the first group 10A in terms of its horizontal left-right position and planar shape, it is similar to the latter in the other respects and thus will not be described in detail here to avoid unnecessary duplication.

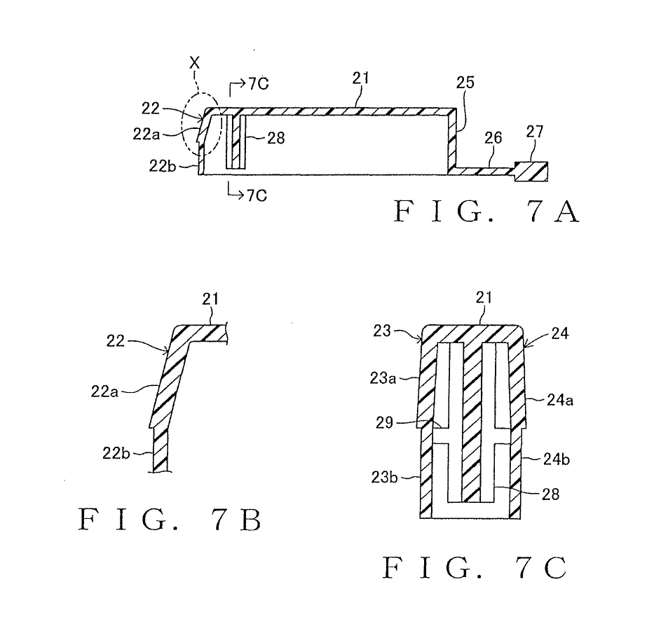

The following describe, with primary reference to FIGS. 7A to 7C, the black key 20 belonging to the third group 20A shown in FIG. 6. FIG. 7A is a longitudinal sectional view of the black key 20 taken along the 7A-7A line of FIG. 6, FIG. 7B is an enlarged view of a section encircled at X in FIG. 7A, and FIG. 7C is an enlarged cross-sectional view of the black key 20 taken along the 7C-7C line of FIG. 7A.

The black key 20 is also formed integrally of resin and includes an upper wall 21, a front wall 22, side walls 23 and 24 and a rear wall 25. The upper wall 21 has a flat shape elongated in the front-rear direction, and the upper and lower surfaces of the upper wall 21 each extend in a horizontal plane. The front wall 22 comprises an upper portion 22a that is an outer appearance part (first part), and a lower portion 22b that is a non-outer-appearance part (second part). The upper portion 22a, which has a rectangular flat shape, extends downward from the front end of the upper wall 21 slightly obliquely in such a manner that its lower end is located slightly forward of its upper end. Further, the lower end of the upper portion 22a has a slightly greater width in the left-right direction than an upper end region of the upper portion 22a, so that the opposite side ends, in the left-right direction, of the lower end of the upper portion 22a are located slightly outward of the opposite ends, in the left-right direction, of the upper end of the upper portion 22a. The lower portion 22b, which also has a rectangular flat shape, extends vertically downward from the lower end of the upper portion 22a. Note, however, that the lower portion 22b has a thickness in the front-rear direction slightly smaller than a thickness in the front-rear direction of the upper portion 22a, and that the front surface of the lower portion 22b is located slightly rearward of the front surface of the lower end of the upper portion 22a. Further, a position, in the front-rear direction, of the rear surface of the lower portion 22b coincides with a position, in the front-rear direction, of the rear surface of the lower end of the upper portion 22a. Furthermore, the lower portion 22b has a uniform width in the horizontal left-right direction from its upper end to its lower end, but the width of the lower portion 22b is slightly smaller than a width, in the horizontal left-right direction, of the upper portion 22a.

Each of the side walls 23 and 24 too comprises an upper portion 23a or 24a that is an outer appearance part (first part), and a lower portion 23b or 24b that is a non-outer-appearance part (second part). Each of the upper portions 23a and 24a has a flat shape elongated in the front-rear direction and extends downward from the left or right end of the upper wall 21 slightly obliquely in such a manner that its lower end is located slightly outward of its upper end. Further, the outer end, in the horizontal left-right direction, of each of the upper portions 23a and 24a is located at one of the outer ends, in the horizontal left-right direction, of the upper wall 21, and the outer surface of each of the upper portions 23a and 24a coincides with one of the outer surfaces, in the horizontal direction, of the upper portion 22a of the front wall 22. Each of the lower portions 23b and 24b also has a rectangular flat shape and extends vertically downward from the lower end of a corresponding one of the upper portions 23a and 24a. The lower portions 23b and 24b extend in parallel to each other. Note, however, that each of the lower portions 23b and 24b has a thickness in the horizontal left-right direction slightly smaller than a thickness in the horizontal left-rear direction of the corresponding upper portion 23a or 24a, and that the outer surface, in the horizontal left-rear direction, of the lower portion 23b or 24b is located slightly inward of the outer surface, in the horizontal left-rear direction, of the corresponding upper portion 23a or 24a. Further, a position, in the horizontal left-rear direction, of the inner surface of each of the lower portions 23b and 24b coincides with a position, in the in the horizontal left-rear direction, of the inner surface of the lower end of the corresponding upper portion 23a or 24a. Furthermore, the thickness, in the horizontal left-right direction, each of the lower portions 23b and 34b is equal to the thickness, in the front-rear direction, of the lower portion 22b of the front wall 22. Furthermore, the lower portions 23b and 24b extend rearward from the lower portion 22b of the front wall 22 at right angles to the latter. In addition, the rear surface of the rear wall 25 coincides with the rear end of the upper surface 21 as view in the front-rear direction.

The rear wall 25 too has a rectangular flat shape and extends downward from the rear end of the upper wall 21. The rear wall 25 has a thickness in the front-rear direction that is equal to the thickness, in the front-rear direction, of the lower portion 22b of the front wall and the thickness in the horizontal left-right direction of each of the lower portions 23b and 24b of the side walls 23 and 24. The upper wall 11, front wall 21, side walls 23 and 24 and rear wall 25 constructed as above together define an interior space of a rectangular shape opening downwardly. Further, the upper ends of the lower portion 22b of the front wall 22 and the lower portions 23b and 24b of the side walls 23 and 24 that constitute the non-outer-appearance part are located more inward of the black key 20 than the upper wall 21 and lower ends of the upper portion 22a of the front wall 22 and the upper portions 23a and 24a of the side walls 23 and 24 that constitute the non-outer appearance part.

The rear wall 25 has, on its rear surface, a hinge section 26 and a fixing section 27 that are similar to the hinge section 16 and the fixing section 17 of the white key 10. Note that the hinge section 26 and the fixing section 27 of the black key 20 are located slightly lower than the hinge section 16 and the fixing section 17 of the white key 10. Further, the upper wall 21 has, on its lower surface, an actuator section 28 than the actuator section 18 of the white key 10. Further, on an upper end portion of the lower portion 23b of the side wall 23 is provided a connection section 29 that interconnects the inner surface of an upper end portion of the lower portion 23b and one outer end of an intermediate portion of the actuator section 28. This connection section 29 too is a section which, when resin has been poured into upper and lower molds 42A and 42B, allows the resin to flow through a mold portion corresponding to the lower portion 23b of the side wall 23 to a mold portion corresponding to the actuator section 28 in a later-described second molding process.

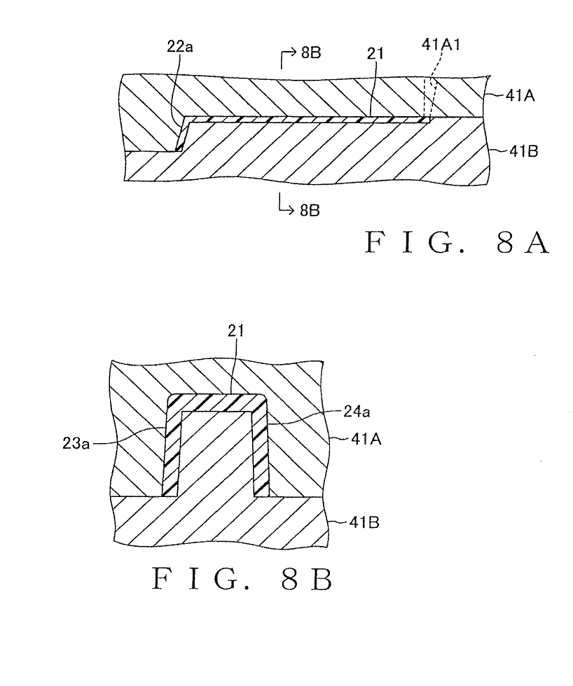

Next, a description will be given about a manner in which the plurality of the black keys 20, each constructed in the aforementioned manner, are formed using the molds. First, the first molding process will be described with primary reference to FIGS. 8A and 8B. FIG. 8A is a longitudinal sectional view showing portions of the black key 20 and the upper and lower molds 41A and 41B, extending along the front-rear direction of the black key 20, in the first molding process for forming the upper wall 21 and the upper portions 22a, 23a and 24a of the front wall 22 and side walls 23 and 24 that constitute the outer appearance part of the black key 20. FIG. 8B is an enlarged cross-sectional view of the black key and the upper and lower molds 41A and 41B taken along the 8B-8B line of FIG. 8A.

The upper and lower molds 41A and 41B are provided which, as shown in FIGS. 8A and 8B, define therebetween a space for integrally forming the upper wall 21 and the upper portions 22a, 23a and 24a of the front wall 22 and side walls 23 and 24. Then, resin is poured into the space through a filler port 41A1 formed through the upper mold 41A so that the upper wall 21 and the upper portions 22a, 23a and 24a of the front wall 22 and side walls 23 and 24 are formed in the upper and lower molds 41A and 41B, after which the upper and lower molds 41A and 42B are pulled upward and downward, respectively, away from each other and then the upper wall 21 and the upper portions 22a, 23a and 24a of the front wall 22 and side walls 23 and 24 having been molded as above are taken out. In this case too, the filler port 41A1 may be provided at any desired position other than the illustrated position as long as an undesired mark of the filler port 41A1 is invisible from outside with the molded black key 20 assembled to the keyboard musical instrument. Further, the resin to be poured is of a relatively high hardness and is of a black color corresponding to the black key 20. In this manner, the first part of the black key 20, comprising the upper wall 21 and the upper portions 22a, 23a and 24a of the front wall 22 and side walls 23 and 24, is molded by the resin being poured into a first mold (41A and 41B), and the thus-molded first part becomes a first component of the black key 20.

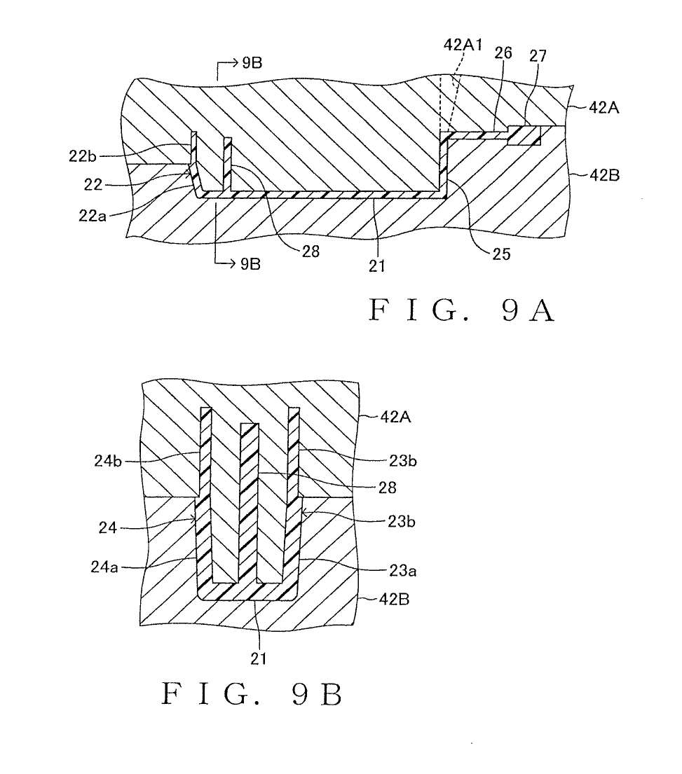

Next, the second molding process will be described with primary reference to FIGS. 9A and 9B. FIG. 9A is a longitudinal sectional view showing the black key 20 and the upper and lower molds 42A and 42B, extending along the front-rear direction of the black key 20, in the second molding process for forming the lower portions 22b, 23b and 24b of the front wall 22 and side walls 23 and 24, the rear wall 25, the hinge section 26, the fixing section 27, the actuator section 28 and the connection section 29 that constitute the non-outer-appearance part of the black key 20. FIG. 9B is an enlarged cross-sectional view of the black key 20 and the upper and lower molds 42A and 42B taken along the 9B-9B line of FIG. 9A. Note that the line along which the longitudinal section of FIG. 9A is taken corresponds to line 7A-7A along which the longitudinal section of FIG. 6A is taken.

The upper and lower molds 42A and 42B are provided which, as shown in FIGS. 9A and 9B, define therebetween a space for integrally forming the black key 20 including the upper wall 21 and the upper portions 22a, 23a and 24a of the front wall 22 and side walls 23 and 24. In this case, the molding comprising the upper wall 21 and the upper portions 22a, 23a and 24a of the front wall 22 and side walls 23 and 24 formed as above in the first molding process, is inserted or assembled into an upper surface recess of the lower mold 42B, and then, the upper mold 42A is positioned over and fixed to an upper portion of the lower mold 42B. Then, resin is poured into the space through a filler port 42A1 formed through the upper mold 42A so that the lower portions 22b, 23b and 24b of the front wall 22 and side walls 23 and 24, the rear wall 25, the hinge section 26, the fixing section 27, the actuator section 28 and the connection section 29, other than the upper wall 21 and the upper portions 22a, 23a and 24a of the front wall 22 and side walls 23 and 24, are formed in the upper and lower molds 41A and 41B, after which the upper and lower molds 42A and 42B are pulled upward and downward, respectively, away from each other and then the black key 20 having been molded as above is taken out. By this insert-molding, the lower portions 22b, 23b and 24b of the front wall 22 and side walls 23 and 24, the rear wall 25, the hinge section 26, the fixing section 27, the actuator section 28 and the connection section 29, other than the upper wall 21 and the upper portions 22a, 23a and 24a of the front wall 22 and side walls 23 and 24, are formed integrally with the upper wall 21 and the upper portions 22a, 23a and 24a of the front wall 22 and side walls 23 and 24 formed in the first molding process. Note that, in this case, the actuator section 18 is formed by the poured resin flowing into a mold portion corresponding to the actuator section 28 through a space (not visible in the figures) corresponding to the lower portion 23b of the side wall 23 and the connection section 29.

In this case too, the filler port 42A1 may be provided at any desired position other than the illustrated position as long as an undesired mark of the filler port 42A1 is invisible from outside with the molded black key 20 assembled to the keyboard musical instrument. Further, the resin to be poured may be of hardness lower than the hardness of the resin used in the first molding process, and the resin may comprise a resin material having a relatively high resilience, such as an ABS material containing much rubber component or a rubber material. Further, in this case, the resin has color, such as brown, yellow or yellow-brown, similar to color of a wooden key. In the aforementioned manner, the second part of the black key 20, comprising the lower portions 22b, 23b and 24b of the front wall 22 and side walls 23 and 24, the rear wall 25, the hinge section 26, the fixing section 27, the actuator section 28 and the connection section 29, other than the first part is molded by the resin being poured into the second mold (42A and 42B) with the first part (first component) inserted in the second mold, and this second part becomes the second component of the black key 20.

According to the instant embodiment, as described above, the black key 20 is integrally formed by the first molding process and the second molding process that is the insert-molding, and thus, the following advantageous benefits are achievable. Namely, because the first molding process does not form the rear wall 25, the hinge section 26, the fixing section 27, the actuator section 28 and the connection section 29, flows of the resin can be simplified, so that weld lines, flow marks, etc. can be prevented from being produced in the upper wall 21 and the upper portions 22a, 23a and 24a of the front wall 22 and side walls 23 and 24 formed as the outer appearance part of the black key 20. Particularly, even where the resin is poured from the back of the black key 20, weld lines are not produced in the front wall 22 because the upper wall 21 and the upper portions 22a, 23a and 24a of the front wall 22 and side walls 23 and 24 are short in length and the upper portion 22a of the front wall 22 has a small width in the horizontal left-right direction. Further, even where a rib constituting the actuator section 28 is provided within the black key 20, sink marks would not be produced in the upper wall 21 just as with the white key 10. Further, by insert-molding the non-outer-appearance part, comprising the lower portions 22b, 23b and 24b of the front wall 22 and side walls 23 and 24, the rear wall 25, the hinge section 26, the fixing section 27, the actuator section 28 and the connection section 29, in the second molding process, integrally with the upper wall 21, the upper portions 22a, 23a and 24a of the front wall 22 and side walls 23 and 24, there is no need to perform a process for connecting the lower portions 22b, 23b and 24b of the front wall 22 and side walls 23 and 24, the rear wall 25, the hinge section 26, the fixing section 27, the actuator section 28 and the connection section 29 to the upper wall 21, the upper portions 22a, 23a and 24a of the front wall 22 and side walls 23 and 24. In this way, the black key 20 for the keyboard musical instrument can be formed into a good outer appearance with a simple method.

Further, in the instant embodiment of the black key 20, an outer surface, in a horizontal plane, of the lower portion 22b of the front wall 22 that is included in the non-outer-appearance part (second part) is located inward of an outer surface, in a horizontal plane, of the lower end of the upper portion 22a of the front wall 22 that is included in, or belong to, the outer-appearance part (first part). Further, outer surfaces, in a horizontal plane, of the lower portions 23a and 24a of the side walls 23 and 24 that are included in the non-outer-appearance part (second part) are located inward of outer surfaces, in a horizontal plane, of the lower ends of the upper portions 23a and 24a of the side walls 23 and 24 that are included in, or belong to, the non-outer-appearance part (second part). Stated differently, the outer surface of the non-outer-appearance part (second part) at least in a connecting portion between the outer-appearance part (first part) of the black key 20 and the non-outer-appearance part (second part) of the black key 20 is located inward of the outer surface position of the outer-appearance part (first part) of the key black 20. Thus, even where some error has occurred in the insert-molding of the lower portions 22b, 23b and 24b of the front wall 22 and side walls 23 and 24 in the second molding process, the molded black key 20 can secure a good outer appearance, without requiring a finishing process of, for example, shaving the lower portions 22b, 23b and 24b of the front wall 22 and side walls 23 and 24.

Further, in the case of the black key 20, the hardness of the resin to be used in the first molding process is relatively high, and the hardness of the resin to be used in the second molding process is lower than the hardness of the resin in the first molding process, just as with the white key 10. Thus, just as with the white key 10, the lower portions 22b, 23b and 24b of the front wall 22 and side walls 23 and 24 of the black key 20 can perform a vibration suppression function to suppress to any uncomfortable sound, but also the hinge section 28 can easily deform resiliently so that the black key 20 can impart a good touch feel at the time of depression of the key 20. Furthermore, the resin to be used in the second molding process has color similar to color of a wooden key, such as brown, yellow or yellow-brown, that is different from the black color of the resin to be used in the first molding process. Thus, in the case of the black key 20, the lower portions 22b, 23b and 24b of the front wall 22 and side walls 23 and 24 can be formed in a wood color and thus have generally the same outer appearance as a wooden key, just as with the white key 10.

Whereas the molding of the white key 10 has been described above as forming the outer appearance part (first part) of the white key 10 in the first molding process and forming the non-outer-appearance part (second part) of the white key 10 in the second molding process. In a modification, however, the non-outer-appearance part (second part) of the white key 10 may be formed in the first molding process, while the outer appearance part (first part) of the white key 10 may be formed in the second molding process.

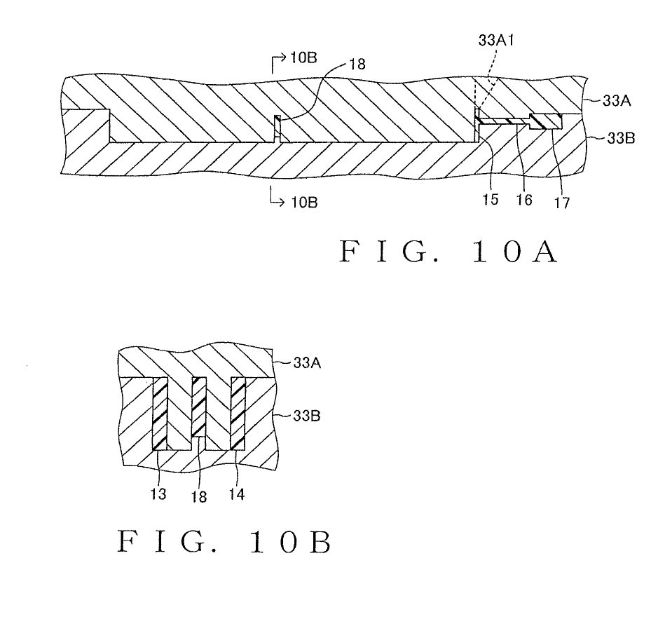

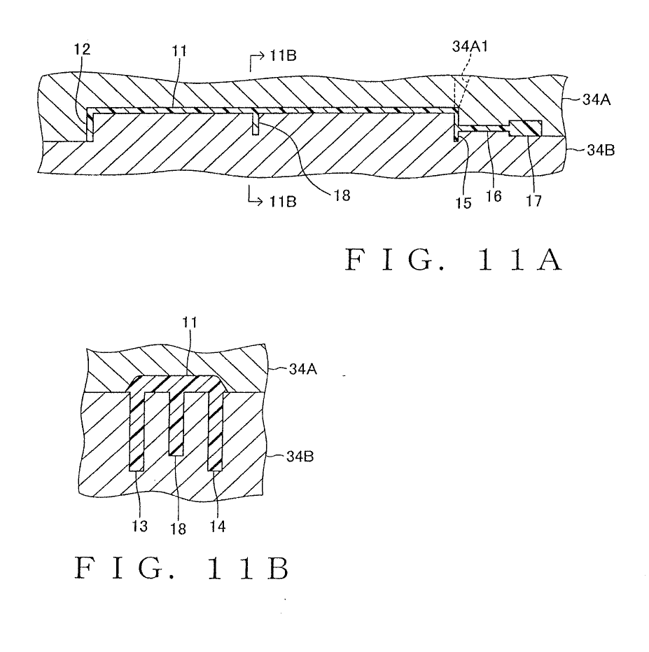

The following describe, with primary reference to FIGS. 10A and 10B, the first molding process to be performed for the above-mentioned modification. FIG. 10A is a longitudinal sectional view showing the white key 10 and upper and lower molds 33A and 33B, extending along the front-rear direction of the white key 10, in the first molding process for integrally forming the side walls 13 and 14, rear wall 15, hinge section 16, fixing section 17, actuator section 18 and connection section 19 that constitute the non-outer-appearance part (i.e., second part) of the white key 10. FIG. 10B is an enlarged cross-sectional view of the white key 10 and the upper and lower molds 32A and 32B taken along the 10B-10B line of FIG. 10A. Note that the line along which the longitudinal section of FIG. 10A and a line along which a later-described longitudinal section of FIG. 11A is taken correspond to the 3A-3A line of FIG. 2.

The upper and lower molds 33A and 33B are provided which, as shown in FIGS. 10A and 10B, define therebetween a space for integrally forming the side walls 13 and 14, the rear wall 15, the hinge section 16, the fixing section 17, the actuator section 18 and the connection section 19 that constitute the non-outer-appearance part of the white key 10. Then, resin is poured into the space through a filler port 33A1 formed through the upper mold 33A so that the side walls 13 and 14, the rear wall 15, the hinge section 16, the fixing section 17, the actuator section 18 and the connection section 19 are integrally formed, after which the upper and lower molds 33A and 33B are pulled upward and downward, respectively, away from each other and then the side walls 13 and 14, the rear wall 15, the hinge section 16, the fixing section 17, the actuator section 18 and the connection section 19 having been molded as above are taken out. In this case too, the filler port 33A1 may be provided at any desired position other than the illustrated position as long as an undesired mark of the filler port 33A1 is invisible from outside with the molded white key 10 assembled to the keyboard musical instrument. Further, the resin to be used in the second molding process for forming the non-outer-appearance part of the white key 10 as described above with reference to FIGS. 5A and 5B is used as the resin to be poured here. Although not clearly shown in FIGS. 10A and 10B, the side walls 13 and 14, the rear wall 15, the hinge section 16, the fixing section 17, the actuator section 18 and the connection section 19 are formed integrally or continuously with one another.

Next, in the second molding process, the upper and lower molds 34A and 34B are provided which, as shown in FIGS. 11A and 11B, define therebetween a space for integrally forming the white key 10 including the side walls 13 and 14, the rear wall 15, the hinge section 16, the fixing section 17, the actuator section 18 and the connection section 19. In this case too, the molding, comprising the side walls 13 and 14, rear wall 15, hinge section 16, fixing section 17, actuator section 18 and connection section 19 formed in the first molding process is inserted or assembled into an upper surface recess of the lower mold 34B. Then, the upper mold 34A is positioned over and fixed to an upper portion of the lower mold 34B. Then, resin is poured into the space through a filler port 34A1 formed through the upper mold 34A so that the upper wall 11 and the front wall 12, other than the side walls 13 and 14, the rear wall 15, the hinge section 16, the fixing section 17, the actuator section 18 and the connection section 19, are formed in the upper and lower molds 34A and 34B, after which the upper and lower molds 34A and 34B are pulled upward and downward, respectively, away from each other and then the white key 10 having been molded as above is taken out. By this insert-molding, the upper and front walls 11 and 12 are formed integrally with the side walls 13 and 14, rear wall 15, hinge section 16, fixing section 17, actuator section 18 and connection section 19 formed in the first molding process.

In this case too, the filler port 34A1 may be provided at any desired position other than the illustrated position as long as an undesired mark of the filler port 34A1 is invisible from outside with the molded white key 10 assembled to the keyboard musical instrument. Further, the resin used in the first molding process for forming the outer appearance part of the white key 10 as described above with reference to FIGS. 4A and 4B is used as the resin to be poured here. Even though the white key 10 is formed as above, the outer appearance part and the non-outer-appearance part of the white key 10 are formed separately from each other. Because the above-described modified molding of the white key 10 is similar in the other respects to the molding of the white key 10 described previously with reference to FIGS. 4A and 4B and FIGS. 5A and 5B, the modified molding of the white key 10 can achieve the same advantageous benefits as the molding of the white key 10 described previously.

Thus, according to the modification, the second part, comprising the side walls 13 and 14, rear wall 15, hinge section 16, fixing section 17, actuator section 18 and connection section 19, is constructed as the first component molded by the resin being poured into a first mold (33A and 33B), while the first part, comprising the upper wall 11 and the front wall 12, is constructed as the second component molded integrally with the first component by the resin being poured into a second mold (34A and 34B) with the first component inserted in the second mold.

Whereas the molding of the black key 20 has been described above as forming the outer appearance part (first part) of the black key 20 in the first molding process and forming the non-outer-appearance part (second part) of the black key 20 in the second molding process. In a modification, however, the non-outer-appearance part (second part) of the black key 20 may be formed in the first molding process, while the outer appearance part (first part) of the black key 20 may be formed in the second molding process.

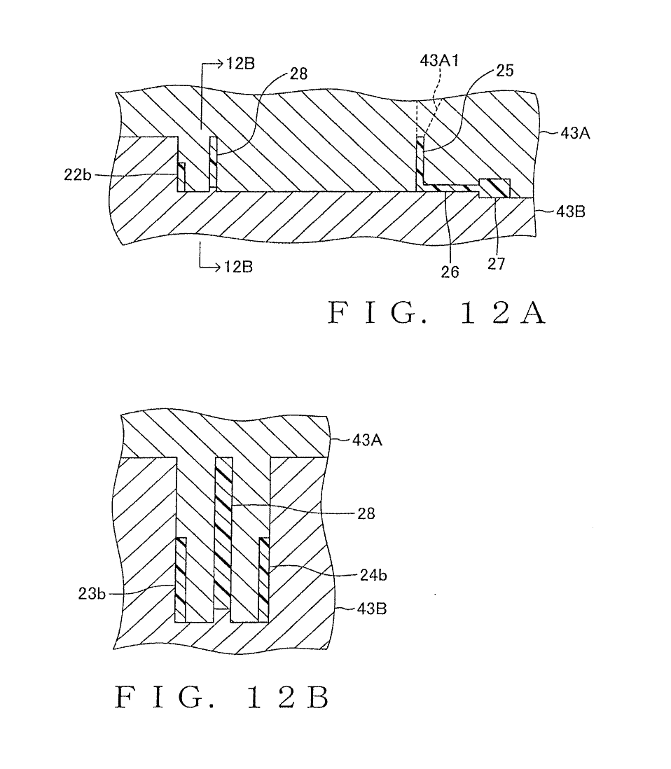

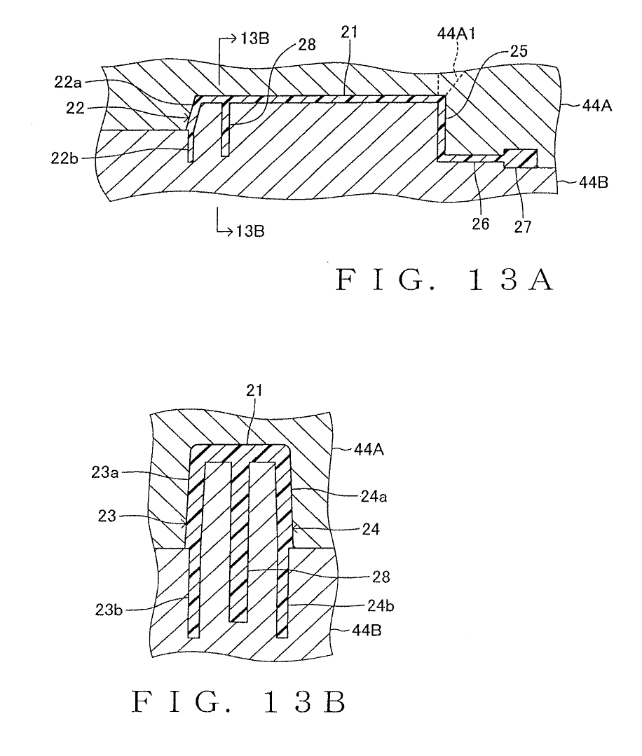

The following describe the first molding process in the above-mentioned modification. FIG. 12A is a longitudinal sectional view showing the black key 20 and the upper and lower molds 43A and 43B, extending along the front-rear direction of the black key 20, in the first molding process for forming the lower portions 22b, 23b and 24b of the front wall 22 and side walls 23 and 24, the rear wall 25, the hinge section 26, the fixing section 27, the actuator section 28 and the connection section 29 that constitute the non-outer-appearance part of the black key 20. FIG. 12B is an enlarged cross-sectional view of the black key 20 and the upper and lower molds 43A and 43B taken along the 12B-12B line of FIG. 12A. Note that the lines along which the longitudinal sections of FIG. 12A and later-described FIG. 13A correspond to the 7A-7A line of FIG. 6.

The upper and lower molds 43A and 43B are provided which, as shown in FIGS. 12A and 12B, define therebetween a space for integrally forming the non-outer-appearance part of the black key 20 comprising the lower portions 22b, 23b and 24b of the front wall 22 and side walls 23 and 24, the rear wall 25, the hinge section 26, the fixing section 27, the actuator section 28 and the connection section 29. Then, resin is poured into the space through a filler port 43A1 formed through the upper mold 43A so that the lower portions 22b, 23b and 24b of the front wall 22 and side walls 23 and 24, the rear wall 25, the hinge section 26, the fixing section 27, the actuator section 28 and the connection section 29 are formed in the upper and lower molds 43A and 43B, after which the upper and lower molds 43A and 43B are pulled upward and downward, respectively, away from each other and then the lower portions 22b, 23b and 24b of the front wall 22 and side walls 23 and 24, the rear wall 25, the hinge section 26, the fixing section 27, the actuator section 28 and the connection section 29 having been molded as above are taken out. In this case too, the filler port 43A1 may be provided at any desired position other than the illustrated position as long as an undesired mark of the filler port 43A1 is invisible from outside with the molded black key 20 assembled to the keyboard musical instrument. Further, the resin used in the second molding process for forming the non-outer-appearance part of the black key 20 as described above with reference to FIGS. 9A and 9B is used as the resin to be poured here. Although not clearly shown in FIGS. 12A and 12B, the lower portions 22b, 23b and 24b of the front wall 22 and side walls 23 and 24, the rear wall 25, the hinge section 26, the fixing section 27, the actuator section 28 and the connection section 29 are formed integrally or continuously with one another.

Then, in the second molding process, the upper and lower molds 44A and 44B are provided which, as shown in FIGS. 13A and 13B, define therebetween a space for integrally forming the black key 20 including the lower portions 22b, 23b and 24b of the front wall 22 and side walls 23 and 24, the rear wall 25, the hinge section 26, the fixing section 27, the actuator section 28 and the connection section 29. In this case too, the molding comprising the lower portions 22b, 23b and 24b of the front wall 22 and side walls 23 and 24, the rear wall 25, the hinge section 26, the fixing section 27, the actuator section 28 and the connection section 29 is inserted or assembled into an upper surface recess of the lower mold 44B, and then, the upper mold 44A is positioned over and fixed to an upper portion of the lower mold 44B. Then, resin is poured into the space through a filler port 44A1 formed through the upper mold 44A so that the upper wall 21 and the upper portions 22b, 23a and 24a of the front wall 22 and side walls 23 and 24, other than the lower portions 22b, 23b and 24b of the front wall 22 and side walls 23 and 24, the rear wall 25, the hinge section 26, the fixing section 27, the actuator section 28 and the connection section 29, are formed in the upper and lower molds 44A and 44B, after which the upper and lower molds 44A and 44B are pulled upward and downward, respectively, away from each other and then the black key 20 having been molded in the aforementioned manner is taken out. By this insert-molding, the upper wall 21 and the upper portions 23a and 24a of the side walls 23 and 24 are formed integrally with the lower portions 22b, 23b and 24b of the front wall 22 and side walls 23 and 24, the rear wall 25, the hinge section 26, the fixing section 27, the actuator section 28 and the connection section 29 formed in the first molding process.

In this case too, the filler port 44A1 may be provided at any desired position other than the illustrated position as long as an undesired mark of the filler port 44A1 is invisible from outside with the molded black key 20 assembled to the keyboard musical instrument. Further, the resin used in the first molding process for forming the outer appearance part of the black key 20 as described above with reference to FIGS. 8A and 8B is used as the resin to be poured here. Even though the black key 20 is formed as above, the outer appearance part and the non-outer-appearance part of the black key 20 are formed separately from each other. Because the above-described modified molding of the black key 20 is similar in the other respects to the molding of the black key 20 described previously with reference to FIGS. 8A and 8B and FIGS. 9A and 9B, the modified molding of the black key 20 can achieve the advantageous benefits as the molding of the black key 20 described previously.

Thus, according to the modification, the second part, comprising the lower portions 22b, 23b and 24b of the front wall 22 and side walls 23 and 24, the rear wall 25, the hinge section 26, the fixing section 27, the actuator section 28, the connection section 29, etc., of the black key 20 is constructed as the first component molded by the resin being poured into a first mold (43A and 43B), while the first part, comprising the upper wall 21 and the upper portions 22a, 23a and 24a of the side walls 23 and 24, of the black key 20 is constructed as the second component molded integrally with the first component by the resin being poured into a second mold (44A and 44B) with the first component inserted in the second mold.

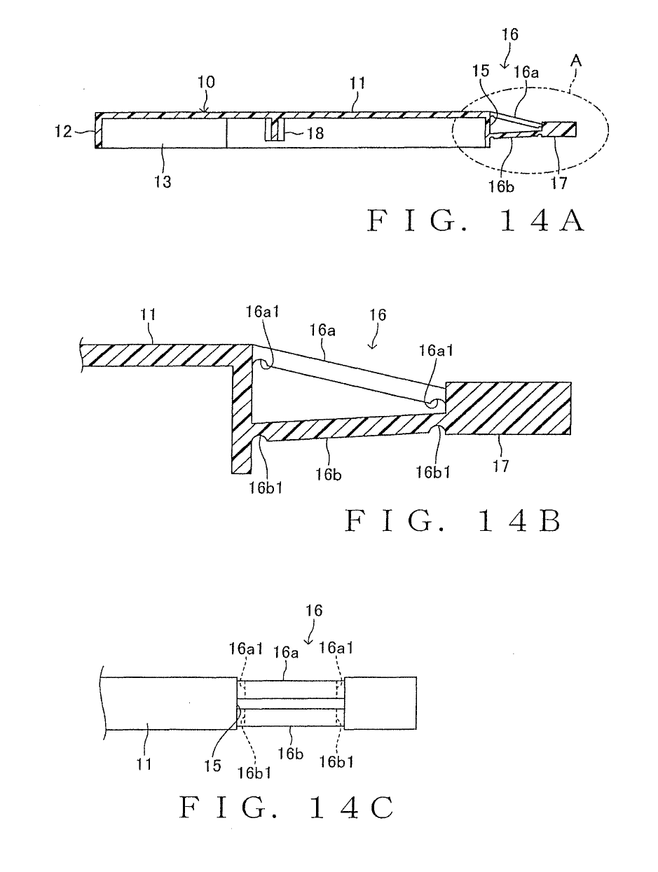

Furthermore, whereas the white key 10 according to the above-described embodiment includes a single hinge section 16 to permit pivoting movement of the white key 10 at the time of depression of the key 10, the present invention is not so limited, and the single hinge section 16 may be replaced with a multi-link mechanism (multi-link hinge section) 16 comprising a pair of hinge members 16a and 16b. The following describe such a modified white key 10 with reference to FIGS. 14A to 14C. FIG. 14A is a longitudinal sectional view of the modified white key 10 corresponding to FIG. 3A, FIG. 14B is an enlarged longitudinal sectional view of a section encircled at A of FIG. 14A, and FIG. 14C is an enlarged plan view of the section encircled at A of FIG. 14A.

According to such a modification, the hinge members 16a and 16b of the multi-link hinge section 16 are each an elongated flat plate-shaped member and having a small thickness in the vertical or up-down direction and a width in the horizontal left-right direction smaller than half the width, in the horizontal left-right direction, of the rear wall 15 of the white key 10. One of the hinge members 16a connects at its front end to a left upper end portion of the rear surface of the rear wall 15 and connects at its rear end to a left upper end portion of the front surface of the fixing section 17. The other hinge member 16b connects at its front end to a right intermediate portion of the rear surface of the rear wall 15 and connects at its rear end to a right lower end portion of the front surface of the fixing section 17. Namely, the respective distal ends of the hinge members 16a and 16b are fixed to the above-mentioned keyboard frame at different heights with respect to the stroke direction (vertical pivoting direction) of the key 10. The hinge members 16a and 16b do not superpose on each other because they are formed by vertical pulling of the molds.

Recesses, each having a semicircular longitudinal sectional shape and extending in the left-right direction, are formed in the lower surfaces of front and rear end portions of the hinge member 16a. Similarly, recesses, each having a semicircular longitudinal sectional shape and extending in the left-right direction, are formed in the lower surfaces of front and rear end portions of the hinge member 16b. The other structural elements in the modification are similar to those in the above-described embodiment and depicted by the same reference numerals as used in the above-described embodiment, and thus, these similar structural elements will not be described here to avoid unnecessary duplication. Further, the modified white key 10 too is formed by the first and second molding processes shown in FIGS. 4A and 4B and FIGS. 5A and 5B. In the first molding processing, the upper wall 11 and the front wall 12 are formed in the exactly the same manner as in the first molding processing of the above-described embodiment. In the second molding processing too, the side walls 13 and 14, the rear wall 15, the modified or multi-link hinge section 16 (hinge members 16a and 16b), the fixing section 17 and the actuator section 18 are formed by insert-molding as in the second molding processing of the above-described embodiment. However, because the modified hinge section 16 comprises the hinge members 16a and 16b, upper and lower molds for forming the modified white key 10 are shaped so as to form the hinge members 16a and 16b, unlike the upper and lower molds 32A and 32B for forming the white key 10 of the above-described embodiment. Resin used in the first and second molding processes here is the same as used in the above-described embodiment.

The modified white key 10 too can achieve the same advantageous benefits as the white key 10 in the above-described embodiment. Because of the multi-link mechanism using the plurality of hinge members 16a and 16b, a pivot point of the white key 10 at the time of depression of the key 10 (i.e., a virtual pivot point determined by combination of respective pivot points of the plurality of hinge members 16a and 16b) is located substantively more rearward than the pivot point of the white key including only one hinge member 16. Thus, a disposed angle of the hinge section 16 (hinge members 16a and 16b) in a steady state can be increased as compared to that in the above-described embodiment. In this case too, the resin used in the second molding process has a lower hardness than the resin used in the first molding process, and thus, the touch feel of the white key 10 at the time of depression of the key 10 does not become heavy, so that a good touch feel of the white key 10 can be maintained. Note that, because the disposed angle of the modified hinge section 16 (hinge members 16a and 16b) in the modification can be increased as compared to that in the above-described embodiment as noted above, the hardness of the resin used in the second molding process can be even further lowered as compared to that used in the above-described embodiment.

Note that the modified hinge section 16 (hinge members 16a and 16b) in the modification can also be applied to the black key 20 in the above-described embodiment. Also, white and black keys 10 and 20 each having the modified hinge section 16 (hinge members 16a and 16b) may be formed using the modified molding methods shown in FIGS. 10A and 10B, FIGS. 11A and 11B, FIGS. 12A and 12B and FIGS. 13A and 13B.

By applying the aforementioned multi-link hinge section 16 (hinge members 16a and 16b) to the keys 10 and 20, it is possible to set the virtual pivot point more rearward even where the keys are of a low cost type where a distance from the key's front end to the actual pivot point of the hinge section 16 is relatively small, and thus, it is possible for a user (human player) to obtain a preferable key-depressing stroke feeling like that obtainable by substantial parallel displacement of the key.

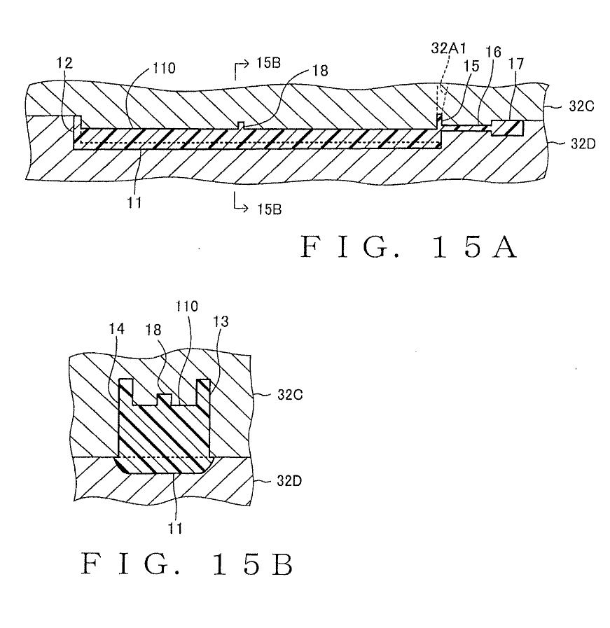

In each of the above-described embodiments, each of the white keys 10 (and black keys 20) has a hollow (space) defined in the interior thereof, i.e. beneath the upper wall 11 (21). However, the present invention is not so limited, and an inner layer may be formed immediately beneath the upper wall 11 (21) so that the key has an increased thickness. FIGS. 15A and 15B are views showing such a modification of the white key 10. According to such a modification, the first molding process for forming the upper wall 11 and the front wall 12 may be performed using the upper and lower molds 31A and 31B as shown in FIGS. 4A and 4B. Further, according to the modification, the second molding process for forming the non-outer-appearance part (i.e., the second part) of the white key 10 may be performed using an upper and lower molds 32C and 32D (second mold) as shown in FIGS. 15A and 15B. FIG. 15A is a longitudinal sectional view showing the white key 10 and the upper and lower molds 32C and 32D extending along the front-rear direction of the white key 10, and FIG. 15B is an enlarged cross-sectional view of the white key 10 and the upper and lower molds 32C and 32D taken along the 15B-15B of FIG. 15A. In FIGS. 15A and 15B, the same reference numerals as in FIGS. 5A and 5B represent the same elements as in FIGS. 5A and 5B, and such elements will not be described here to avoid unnecessary duplication.

The modified white key 10 shown in FIGS. 15A and 15B includes an interior layer 110 surrounded by the front wall 12 and the side walls 13 and 14 and constituting a lower layer of the upper wall 11. Although the interior layer 110 is formed substantially integrally with the underside of the upper wall 11 in close contact with the underside of the upper wall 11, it belongs to the second part invisible from outside the key 10. Thus, the interior layer 110 is formed in another process than the upper wall 11; for example, if the upper wall 11 is formed in the first molding process, the interior layer 110 is formed in the second molding process. Although the interior layer 110 is formed in another process than the upper wall 11, it is formed integrally with the underside of the upper wall 11 in close contact with the underside of the upper wall 11 because it is insert-molded. However, the interior layer 110 is formed of resin softer and lighter than the resin forming the upper wall 11. Thus, even if the thickness of the key 10 increases due to the addition of the interior layer 110, it is possible to provide the key 10 capable of imparting a good key-depressing touch feel without unnecessarily increasing the overall weight of the key 10. This provides a significant advantageous merit unique to the present invention which permits two-stage molding using two different types of resin. Note that the thickness of the interior layer 110 may be set according to a desired design choice. Although not detailed here, the black key 20 may also have an interior layer, similar to the above, on the underside of the upper wall 21.

Further, whereas the embodiment and modifications have been described above in relation to the case where pluralities of white keys 10 belonging to the first and second groups 10A and 10B and the plurality of black keys 20 belonging to the third group 20A are molded or formed simultaneously with one another for each of the groups 10A, 10B and 20B (on a group-by-group basis), the basic principles of the present invention are applicable to a case where each of the white keys 10 and black keys is formed independently of one another. The basic principles of the present invention are also applicable to white and black keys 10 and 20 that do not have the hinge section 16 or 26 and the fixing section 17 or 27. In such a case, pluralities of white and black keys 10 and 20 are formed independently of one another, through-holes or projections are formed in or on opposite side walls of each of the white and black keys 10 and 20, each of the white and black keys 10 and 20 is vertically pivotably supported on the key frame about the through-holes or projections engaged with respective support portions of the key frame. Also, in this case, force for returning each of the depressed white and black keys 10 and 20 to a released state is imparted to the key 10 or 20 by means of a spring, hammer, etc. provided separately from the key 10 or 20.

Furthermore, the embodiment and modifications have been described above in relation to the case where the resin to be used for forming the non-outer-appearance part (the second part) of each of the white and black keys 10 and 20 has a wood color. In an alternative, however, the resin to be used for forming the non-outer-appearance part (the second part) may be of the same color as the resin to be used in the first molding process or may be of a different color (e.g., red or blue) from the resin to be used in the first and second molding processes. Using the different color, white and black keys 10 and 20 of the keyboard musical instrument rich in aesthetic variation can be molded by differentiating the color of the side walls 13 and 14 from the color of the upper wall 11 and front wall 12 and differentiating the color of the lower portions of the front wall 22 and side walls 23 and 24 from the color of the upper portions 22a, 23a and 24a of the front wall 22 and side walls 23 and 24.

Furthermore, in the above-described embodiment and modifications, the side walls 13 and 14, and the lower portions 22b, 23b and 24b of the front wall 22 and side walls 23 and 24 are constructed to be capable of performing the vibration suppression function, and the resin to be used for forming the non-outer-appearance part (second part) of the white and black keys 10 and 20 has a lower hardness than the resin to be used for forming the outer appearance part (first part) of the white and black keys 10 and 20 in order to allow the hinge section 16 or 26 to resiliently deform with ease. Alternatively, in a case where the vibration suppression function of the side walls 13 and 14 and the lower portions 22b, 23b and 24b of the front wall 22 and side walls 23 and 24 and the resiliency of the hinge section 16 or 26 is not required, the resin to be used for forming the outer appearance part (first part) and the resin to be used for forming the non-outer-appearance part (second part) may have the same hardness.

This application is based on, and claims priority to, JP PA 2014-082858 filed on 14 Apr. 2014. The disclosure of the priority application, in its entirety, including the drawings, claims, and the specification thereof, are incorporated herein by reference.

What is claimed is:

1. A key for a keyboard musical instrument comprising a combination of:
a first part including portions normally visible from outside with the key assembled to the keyboard musical instrument; and
a second part including portions normally invisible from outside with the key assembled to the keyboard musical instrument, and
wherein one of said first part and said second part is constructed as a first component by resin being poured into a first mold, and other of said first part and said second part is constructed as a second component, molded integrally with said first component, by resin being poured into a second mold with said first component inserted in said second mold.

2. The key as claimed in claim 1, which comprises: an upper wall of a flat shape extending horizontally to define an upper surface of the key; a front wall of a flat shape extending downward from a front end of said upper wall; side walls, each having a flat shape, extending downward respectively from left and right ends portions of said upper wall; and a downwardly-opening interior space defined by the upper wall, the front wall and the side walls, and
wherein individual one of the upper wall, the front wall and the side walls belongs to at least one of the first part and the second part.

3. The key as claimed in claim 2, wherein said key is a white key, and
wherein the upper wall and the front wall belong to said first part, and the side walls of the key belong to said second part.

4. The key as claimed in claim 2, wherein said key is a black key, and
wherein the upper wall, an upper portion of the front wall and upper portions of the side walls of the key belong to said first part, and a lower portion of the front wall and lower portions of the side walls of the key belong to said second part.

5. The key as claimed in claim 1, which comprises: an upper wall of a flat shape extending horizontally to define an upper surface of the key; a front wall of a flat shape extending downward from a front end of said upper wall; side walls, each having a flat shape, extending downward respectively from left and right ends portions of said upper wall; and an inner layer surrounded by the front wall and the side walls and forming a lower layer of the upper wall, and
wherein at least said upper wall belongs to said first part, and at least said inner layer belongs to said second part.

6. The key as claimed in claim 1, wherein an outer surface of said second part in a connection portion between said first part and said second part is located inward of an outer surface of said first part in the connection portion.

7. The key as claimed in claim 1, wherein the resin for forming said second part is of a lower hardness than the resin for forming said first part.

8. The key as claimed in claim 1, wherein the resin for forming said first part is of a different color from the resin for forming said second part.

9. The key as claimed in claim 1, which comprises a hinge section provided at a rear end of the key and adapted to be fixed to a frame of the keyboard musical instrument, said hinge section being constructed to deform in response to motion of the key and thereby allow the key to perform stroke movement, and
wherein said hinge section belongs to said second part and is formed integrally with a remaining portion of said second part.

10. The key as claimed in claim 9, wherein said hinge section includes a plurality of hinge members fixed to the frame at different heights with respect to a stroke direction of the key.

11. A key unit for a keyboard musical instrument comprising:
a plurality of the keys recited in claim 9; and
a fixing section interconnecting the hinge sections of two or more of the keys belonging to a group, the two or more keys belonging to the group being keys that do not adjoin each other, the hinge sections of the two or more keys being fixed via the fixing section to the frame of the keyboard musical instrument.

12. The key unit as claimed in claim 11, wherein said fixing section belongs to said second part and is formed integrally with a remaining portion of said second part.

13. A method for manufacturing a key for a keyboard musical instrument, the key comprising a combination of a first part including portions normally visible from outside with the key assembled to the keyboard musical instrument; and a second part including portions normally invisible from outside with the key assembled to the keyboard musical instrument, the method comprising:
a first step of molding a first component, corresponding to one of the first and second parts, by pouring resin into a first mold; and
a second step of molding a second component, corresponding to other of the first and second parts, integrally with the first component by inserting the first component, molded by said first step, into a second mold and pouring resin into said second mold.

14. The method as claimed in claim 13, wherein the key comprises an upper wall of a flat shape extending horizontally to define an upper surface of the key; a front wall of a flat shape extending downward from a front end of the upper wall; and side walls, each having a flat shape, extending downward respectively from left and right ends portions of the upper wall; and a downwardly-opening interior space defined by the upper wall, the front wall and the side walls,
wherein, in a case where the key is a white key, said first step and said second step are performed using said first mold and said second mold constructed so that the upper wall and the front wall of the key belong to the first part and the side walls of the key belong to the second part, and
in a case where the key is a black key, said first step and said second step are performed using said first mold and said second mold constructed so that the upper wall, an upper portion of the front wall and upper portions of the side walls of the key belong to the first part and that a lower portion of the front wall and lower portions of the side walls of the key belong to the second part.

15. The method as claimed in claim 13, wherein the key further includes an upper wall of a flat shape extending horizontally to define an upper surface of the key; a front wall of a flat shape extending downward from a front end of the upper wall; side walls, each having a flat shape, extending downward respectively from left and right ends portions of the upper wall; and an inner layer surrounded by the front wall and the side walls and forming a lower layer of the upper wall, and
wherein said first step and said second step are performed using said first mold and said second mold constructed so that at least the upper wall belongs to the first part and that at least the inner layer belongs to the second part.
